(19) United States
(12) Patent Application Publication
(10) Pub. No.: US 2004/0043295 A1
(43) Pub. Date: Mar. 4, 2004

(54) Rechargeable composite polymer battery

(76) Inventors: Rafael Rodriguez, New London, CT (US); Kuzhikalail M. Abraham, Needham, MA (US); Joseph DiCarlo, Groton, CT (US)

Correspondence Address: John R. Doherty, P.O. Box 706, Stevenson, CT, 06491-0706, US

(21) Appl. No.: 10/645,154

(22) Filed: Aug. 21, 2003

Related U.S. Application Data
(60) Provisional application No. 60/405,162, filed on Aug. 21, 2002.

(51) Int. Cl. H01M 10/40; H01M 10/04; H01M 4/58; H01M 4/52; H01M 4/50; H01M 4/48

(52) U.S. Cl. 429/303; 429/246; 429/316; 429/314; 429/307; 429/231.5; 429/231.3; 429/223; 429/224; 429/231.1; 29/623.5

(57) ABSTRACT

Rechargeable composite polymer batteries are disclosed employing composite polymer electrolytes comprising an inorganic oxide, exemplified by fumsilic(SiO₂), and an organic polymer, exemplified by poly(vinylidene fluoride)-hexafluoropropene copolymer (PVDF-HFP), gelled with Li-ion battery electrolytes. The composite polymer electrolytes are prepared by forming a suspension of the inorganic oxide in a solution of the organic polymer contained in a suitable carrier solvent, spraying the suspension onto the surfaces of Li-ion battery electrodes to form inorganic oxide-organic polymer composite films that adhere to the electrode surfaces, and gelling the films with Li-ion battery electrolytes in-situ to form composite inorganic oxide-organic polymer gel electrolytes. Li-ion battery cells are then constructed with the resulting electrode-polymer electrolytes.

### PRIORITIES

This application claims priority to our copending provisional application Serial No. 60/405,162, entitled A Rechargeable Composite Polymer Battery, filed on Aug. 21, 2002.

### STATEMENT REGARDING FEDERALLY SPONSORED RESEARCH OR DEVELOPMENT

This invention was carried out with United States Government support provided under Department of Defense Contract Number F29061-00-C-0036. Therefore, the United States Government has certain rights in this invention.

### FIELD OF THE INVENTION

This invention relates to high energy density rechargeable lithium and lithium-ion batteries, and more particularly to novel and improved composite gel polymer electrolytes for use in such batteries. In another aspect, the invention relates to a novel and improved method of fabricating rechargeable lithium batteries by forming composite polymer electrolytes in-situ on the electrode surfaces using spray coating techniques.

### BACKGROUND OF THE INVENTION

The development of lithium batteries utilizing polymer electrolytes have been actively pursued because of the advantages they offer compared with batteries containing liquid electrolytes. In a polymer electrolyte-based battery, the electrolyte serves both as the separator for electronically isolating the electrodes, and as the ion-conducting medium for transporting Li ions between the negative and positive electrodes during discharge and charge of the battery. The polymer electrolyte-based design allows the Li-ion cell or battery to be packaged in a sealed plastic foil film as opposed to a sealed metal can with the result of achieving higher specific energy because of the weight saved in the packaging material. Also, polymer electrolyte cells packaged in plastic foil films can be shaped to fit the shape of the device they power, thereby providing a wider field of application.

Traditional polymer electrolytes are composed of Li salt complexes of long chain polymers having electron donor atoms such as oxygen and nitrogen. The well known examples are electrolytes based on poly(ethylene oxide)(PEO). These solid polymer electrolytes unfortunately have low conductivities, usually of the order of 10⁻⁵ S/cm or lower, at and below room temperature. Consequently, lithium batteries utilizing these types of polymer electrolytes are used for applications at elevated temperature environments, usually in the 50-100° C. range.

Polymer electrolytes with higher conductivities have been obtained by plasticizing solid polymer electrolytes with the addition of one or more organic solvents usually used in liquid electrolyte-based lithium or Li-ion batteries. Polymer hosts which have been used to prepare plasticized polymer electrolytes include polyacrylonitrile, poly(vinyl chloride), poly(vinyl pyrrolidinone), poly(ethylene glycol diacrylate) and poly(vinylidene fluoride) and its copolymers. These polymer electrolytes, popularly known as gel polymer electrolytes, show conductivities greater than 10⁻³ S/cm at room temperature.

U.S. Pat. No. 5,219,679 issued to Abraham et al describes gel electrolytes prepared with polyacrylonitrile as the host polymer and ethylene carbonate and propylene carbonate as the plasticizing solvents containing a Li salt such as LiPF₆, LiBF₄, LiSO₃CF₃, LiAsF₆, LiClO₄, and LiN(SO₂CF₃)₂.

Another U.S. Pat. No. 5,296,318 issued to Gozdz et al. describes porous gel electrolytes in which the polymer is a copolymer of poly(vinylidene fluoride) and hexaflouropropene and the plasticizing solvent is a mixture of ethylene carbonate and dimethyl carbonate. These gel electrolytes have been used to fabricate Li batteries with performance over a wider temperature range than those based on the aforementioned solid polymer electrolytes of the conventional structures. Thus, gel polymer electrolyte-based Li and Li-ion batteries have the potential for operation in the ambient temperature range of −20 to +60° C. However, despite their higher conductivities and superior charge/discharge performance at ambient temperatures, it has been difficult to develop practical Li and Li-ion batteries based on gel polymer electrolytes because of their poor mechanical properties, which makes manufacturing difficult. Consequently, improved polymer electrolytes and innovative methods to prepare these electrolytes and use them to fabricate batteries are desired.

It is an important object of this invention to provide lithium and Li-ion polymer batteries with high power and long cycle life at ambient temperatures.

Another object of this invention is to provide composite gel polymer electrolytes having a high ionic conductance, or conversely low resistance, for use in high energy density rechargeable lithium and Li-ion batteries or cells.

Still another object of this invention is to provide a process for coating electrode surfaces with very thin films composed of composite organic polymers and forming gel polymer electrolytes in-situ by gelling the coated films with electrolytes used in Li-ion batteries.

A more specific object of this invention is to provide a method of preparing thin films of the polymer electrolytes on electrode surfaces and fabricating Li-ion batteries with the resulting electrode/electrolyte assembly.

### SUMMARY OF THE INVENTION

Briefly, the foregoing and other objects of the invention are achieved by the preparation of composite polymer electrolytes comprising an inorganic oxide and an organic polymer, gelled with an electrolyte solution containing a lithium salt dissolved in an organic solvent. The composite polymer electrolytes can be formed as thin films or coatings on electrode surfaces such as by conventional spraying techniques. Coated electrodes so produced can then be used to construct lithium and Li-ion batteries with improved characteristic and performance over those of the prior art.

Accordingly, there is provided in accordance with the invention an electric current producing rechargeable polymer battery or cell comprising a positive electrode, a negative electrode and a composite polymer electrolyte comprising a mixture of finely-divided inorganic oxide and an organic polymer interposed between the two electrodes. The composite polymer mixture is gelled with a non-aqueous electrolyte solution containing a lithium salt dissolved in an organic solvent. The composite polymer electrolyte serves as both an electrolyte and a separator medium electronically insulating the electrodes while transporting lithium ions therebetween.

Preferably, the composite polymer electrolyte of the invention is in the form of a thin film coating applied to the surface of at least one of the positive and negative electrodes or both, providing a pre-construction electrode-electrolyte assembly for fabricating rechargeable polymer batteries or cells.

The composite polymer electrolyte of the invention may be composed of a number of inorganic oxides and organic polymers that are known and readily available in the art. Preferably, however, the inorganic oxide used in the composite polymer electrolyte is an oxide selected from the group of aluminum oxide (Al₂O₃), titanium oxide (TiO₂), silicon oxide (SiO₂) and mixtures thereof. The organic polymer is preferably a polymer selected from the group of poly(vinylidene fluoride)-hexafluoropropene copolymer, (PVDF-HFP), poly(ethylene oxide), poly(propylene oxide), polyacrylonitrile, poly(vinyl pyrrolidinone) and mixtures thereof. The most preferred inorganic oxide and organic polymer combination for use in fabricating the composite polymer electrolyte of the invention is silicon oxide and poly(vinylidene fluoride)-hexafluoropropene copolymer, (PVDF-HFP).

The proportions of both the inorganic oxide and organic polymer used in the composite polymer electrolyte of the invention may vary over a wide range depending upon the particular components that are chosen for use in the electrolyte. Preferably, the proportions will be maintained within a range of from about 50 to about 95 percent by weight inorganic oxide and from about 5 to about 50 percent by weight organic polymer.

The particular electrolyte solution used in the fabrication of the composite polymer electrolyte of the invention is not critical and may be chosen from a number of well known non-aqueous electrolyte solutions heretofore employed in the manufacture of lithium and Li-ion batteries. Generally speaking, any non-aqueous electrolyte solution containing a lithium salt dissolved in an organic solvent may be employed. Suitable liquid electrolytes for use in the invention include those containing the following lithium salts: e.g., lithium hexafluorophosphate (LiPF₆), lithium tetrafluoroborate (LiBF₄), lithium trifluoromethane sulfonate (LiSO₃CF₃), lithium hexafluoroarsenate (LiAsF₆), lithium perchlorate (LiClO₄), lithium bis-trifluoromethanesulfonimide (LiN(SO₂CF₃)₂) lithium bis-pentafluoroethanesulfonimide, (LiN(SO₂C₂F₅)₂), lithium bis-oxalatoborate (LiBOB), and lithium bis(trifluoroborane)imidazolide (LiIm(BF₃)₂). Lithium hexafluorophosphate (LiPF₆) is the preferred salt. Suitable organic solvents include, carbonates, esters, ethers, lactones and mixtures thereof. The preferred solvents are the organic carbonates such as ethylene carbonate (EC), propylene carbonate (PC), dimethyl carbonate (DMC), diethyl carbonate (DEC), ethyl methyl carbonate (EMC), and solvent mixtures thereof.

The positive and negative electrodes used in the rechargeable composite polymer battery of the invention may be any one of the usual electrode materials employed in typical lithium and Li-ion batteries of the prior art. Thus, for example, the negative electrode may be graphitic carbon, lithium metal or lithium alloys while the positive electrode may be a transition metal oxide selected from the group consisting of V₃O₈, V₆O₁₃, LiCoO₂, LiMn₂O₄, LiNiₓM_{y}O₂ where x=0<x<0.6 and M=Co, Mn and y=0<y<0.6, LiNi_{0.33}Co_{0.33}Mn_{0.33}O₂, and LiMPO₄ where M=Fe, V, Mn and mixtures thereof.

The invention also contemplates a process for fabricating a rechargeable polymer battery comprising: providing a positive and a negative electrode; preparing a suspension of finely-divided inorganic oxide and an organic polymer dissolved in a solvent; coating a surface of at least one of the electrodes with the suspension; evaporating the solvent from the suspension; gelling the residue from the evaporated suspension with a non-aqueous electrolyte solution containing a lithium salt in an organic solvent, and placing the coated electrode adjacent to the other of the electrodes with the gelled coating therebetween to form said composite polymer battery.

### BRIEF DESCRIPTION OF THE DRAWINGSBRIEF DESCRIPTION OF THE DRAWINGSBRIEF DESCRIPTION OF THE DRAWINGSBRIEF DESCRIPTION OF THE DRAWINGS

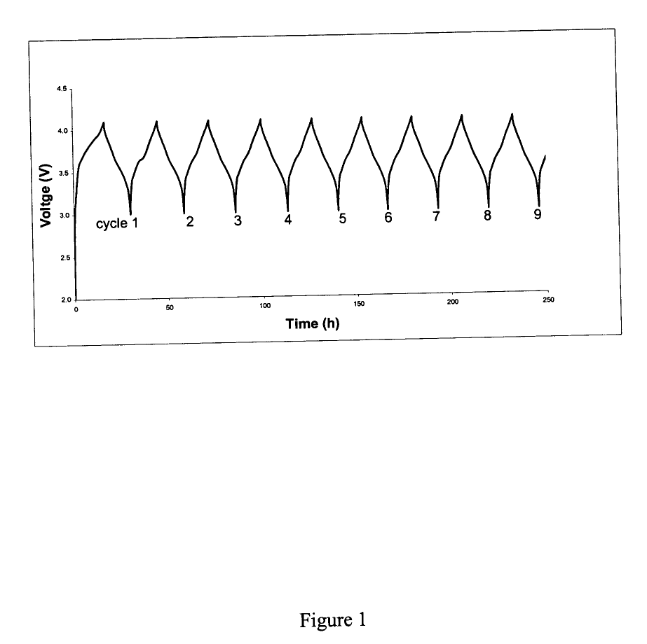

FIG. 1 is a graph illustrating the charge/discharge cycling behavior of lithium-ion gel-polymer pouch cells constructed with a silica-polymer composite electrolyte film in accordance with the invention. The current density exhibited during the test was as follows: i_{d}=0.19 mA/cm². i_{c}=0.19 mA/cm². The figure includes cycles 1-9.

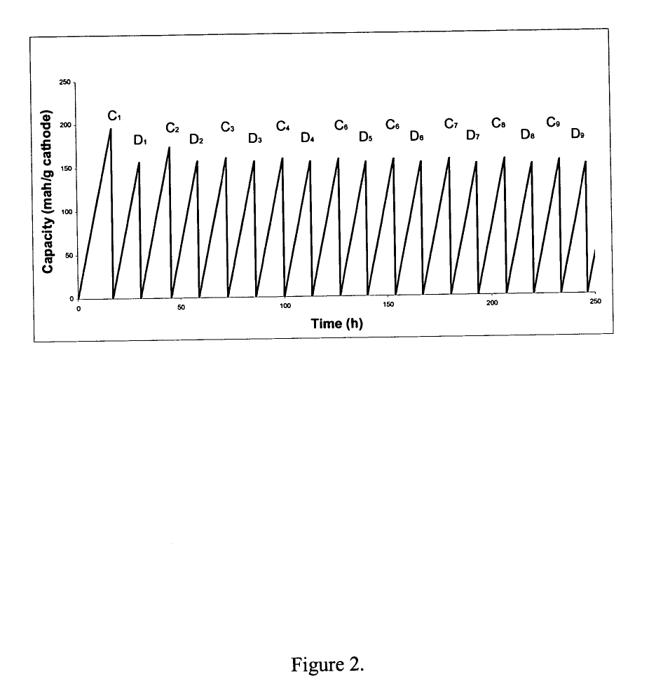

FIG. 2 is a graph illustrating charge and discharge capacities in the nine cycles of the cell shown in FIG. 1. C in the figure is charge capacity, D is discharge capacity and subscript denotes cycle number.

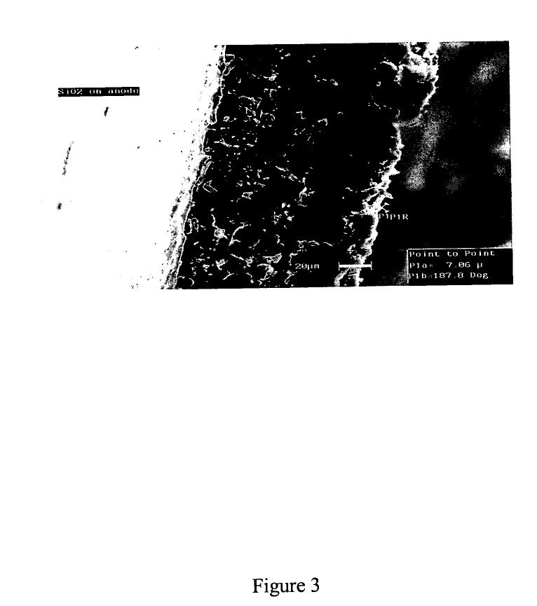

FIG. 3 is a scanning electron micrograph (SEM) of the cross-section of a MCMB carbon electrode coated with the composite polymer/inorganic oxide.

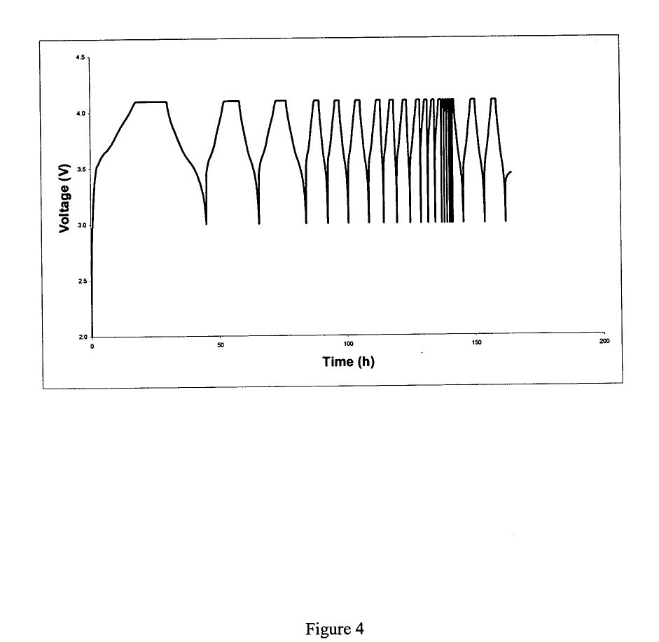

FIG. 4 is the charge/discharge cycling behavior of a lithium ion coin cell prepared with alumina/PVDF-HFP composite electrolyte cycled between 4.1 and 3.0 Volts at different C rates: C/20, C/10, C/5, C/2, 2C, 4C, and 8C.

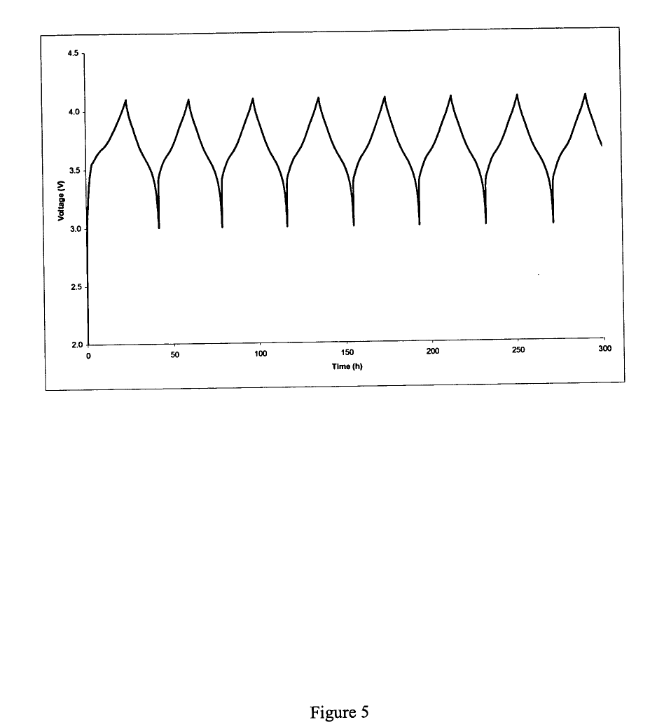

FIG. 5 is a graph illustrating charge/discharge cycling behavior of lithium-ion gel-polymer pouch cells constructed with a PEO-silica composite polymer electrolyte film. Current density: i_{d}=0.13 mA/cm². i_{c}=0.13 mA/cm². The figure includes cycles 1-8.

### DESCRIPTION OF THE PREFERRED EMBODIMENTS

In a preferred embodiment of this invention, polymer electrolytes comprising composites of silica (SiO₂) and an organic polymer, gelled with non-aqueous liquid electrolytes have been developed and evaluated. A preferred example of the organic polymer used to form the composite polymer electrolytes is poly(vinylidene fluoride)-hexafluoropropene copolymer (PVDF-HFP). Although PVDF-HFP is a preferred polymer embodiment, other organic polymers such as poly(ethylene oxide), poly(ethylene glycol diacrylate) and polyacrylonitrile can be used. The organic liquid electrolyte used to form the gel polymer electrolytes of this invention can be any liquid electrolyte that is used in rechargeable lithium batteries. The preferred liquid electrolytes are those used in Li-ion batteries. These include, for example, solutions of lithium hexafluorophosphate (LiPF₆) dissolved in an organic solvent. Other Li salts that can be employed in the liquid electrolyte include LiBF₄, LiSO₃CF₃, LiAsF₆, LiClO₄, LiN(SO₂CF₃)₂, LiN(SO₂C₂F₅)₂, lithium oxalatoborate, known as LiBOB, and lithium bis(trifluoroborane)imidazolide, depicted as Im(BF₃)₂,. The solvent is preferably an organic carbonate solvent such as ethylene carbonate (EC), propylene carbonate (PC), dimethyl carbonate (DMC), diethyl carbonate (DEC), ethyl methyl carbonate (EMC), and solvent mixtures containing two or more of these solvents. The choice of the solvents and Li salts used in the battery is based on the specific performance requirements of the battery or cell.

Although high conductivity is a very important factor in developing polymer electrolytes for rechargeable lithium and lithium-ion batteries, it is equally important to develop a polymer electrolyte that is easily and efficiently adapted to the over-all construction of practical batteries. It has been surprisingly discovered that the composite polymer electrolytes of this invention can be prepared in-situ by spray-coating a silica/PVDF-HFP composite film on the surface of a porous metal oxide cathode or on the surface of a carbon anode of a Li-ion battery, followed by gelling the composite film with an electrolyte used in Li-ion batteries.

The composite polymer electrolyte was prepared independent of the electrode in order to measure its conductivity. The typical conductivity of the composite polymer electrolyte of this invention was found to be about 2.5×10⁻⁴ S/cm at room temperature. In a typical preparation of the composite electrolyte, a 0.6 gram mixture containing 83 weight percent of SiO₂ and 17 weight percent of PVDF-HFP was thoroughly mixed. The conductivity of this mixture was less than about 10⁻⁶ S/cm at room temperature. Then 6 milliliters (ml) of an electrolyte solution consisting of 1 molar (M) LiPF₆ in a 1:1:1 (by weight) mixture of ethylene carbonate, dimethyl carbonate and diethyl carbonate (EC:DMC:DEC) was added to the mixture to obtain a gel polymer electrolyte. The conductivity of the resulting gel polymer electrolyte was about 2.5×10⁻⁴ S/cm at room temperature.

While the composite polymer electrolytes of this invention can be prepared as free-standing films, the polymer electrolytes are preferably prepared as thin films deposited onto the electrodes of Li or Li-ion batteries using spray coating techniques. Accordingly, in the preparation of the preferred polymer electrolyte, a suspension of fumed silica was prepared in a solution of PVDF-HFP copolymer in N-methyl pyrrolidinone (NMP) and ethyl alcohol. The composition of the suspension was about 0.6 gram of silica (83%) and PVDF-HFP(17%) in 30 ml of a solvent mixture consisting of 90% ethyl alcohol and 10% NMP. It was then spray coated on to each side of a Li-ion battery carbon anode (26 cm² area/side) consisting of mesocarbonmicrobead graphite, popularly known in the industry as MCMB carbon, maintained at 150-200° C. A typical carbon anode had 162 milliampere-hour (mAh) capacity. The spray coating was achieved using an ultrasonic sprayer. The solvents were evaporated from the coated film leaving a silica-PVDF-HFP composite film of approximately 10 to 20 micron thickness on the carbon anode. Then, two LiNi_{0.8}Co_{0.2}O₂ cathodes, each with a capacity of 75 mAh, were coated similarly with silica-PVDF-HFP composite films of about the same thickness. After completing the coating, 1 ml of a 1 molar (M) LiPF₆ in a 1:1:1 (by weight) mixture of EC:DMC:DEC was added to the silica-polymer composite films on the electrodes to form gel polymer electrolytes in-situ. Finally, the anode was sandwiched between the two cathodes so that the composite polymer electrolyte films on the electrodes formed a separator between the anode and cathode, thereby forming a Li-ion cell. The cell was placed inside a metallized plastic foil pouch and sealed under vacuum. The resulting Li-ion cell was activated by formation charging to 4.1V at a current density of 0.14 mA/cm². It was then cycled between 4.1V and 3.0V at a current density of 0.19 mA/cm². It was surprisingly discovered that the cell with the composite polymer electrolyte serving both as the separator and the ion conducting medium performed exceptionally well. The cycling data are presented in FIG. 1.

The electrochemical performance of these cells was compared to standard lithium-ion cells made from the same anode and cathode materials, the same liquid electrolyte and a traditional porous plastic separator. It was found that the cell made with the composite silica-polymer gel electrolyte (CSPGE) performed better electrochemically. Thus, they cycled with higher cathode utilization (more than 150 mAh/g of active cathode material) and exhibited excellent charge/discharge capacity retention as seen in FIG. 2.

The process for preparing composite polymer electrolytes according to the invention is useful in the preparation of current-producing electrochemical cells with either Li metal anodes or a Li intercalating material. In the former case, the electrolyte film is deposited by spray coating the composite film on a Li foil surface and the cathode surface. For Li-ion battery cells, the electrolyte film is deposited by spray coating it onto the anode electrodes comprising Li alloys, carbonaceous materials such as graphite, mesocarbonmicrobeads and hard carbon, or on Li intercalating transition metal compounds such as lithium titanates (Li₄Ti₅O₁₂), WO₂, TiS₂ and MoO₂. The cathode electrodes for both Li and Li-ion batteries are usually materials selected from the same family of compounds and may consist of transition metal oxides such as V₃O₈, V₆O₁₃, LiCoO₂, LiMn₂O₄, LiNiₓM_{y}O₂ where x=0<x<0.6 and M=Co, Mn and y=0<y<0.6, LiMPO₄ where M=Fe, V, Mn and their mixtures, and LiNi_{0.33}Co_{0.33}Mn_{0.33}O₂. These cathode electrodes are prepared as porous electrodes containing a binder and an electronically conductive additive, usually a high surface area carbon such as carbon black. The electrolyte film is coated on the surface of these electrodes and then gelled with the electrolyte solution. The anodes and cathodes containing the composite polymer electrolyte films on their surfaces are then combined to form either a Li anode battery or a Li-ion battery.

The following examples will serve to further illustrate the invention.

### EXAMPLE 1

This example illustrates the preparation and characterization of electrodes coated with the composite polymer electrolytes of the invention. A suspension of fumed silica/PVDF was prepared at room temperature in the following sequence. First, 0.100 g of PVDF-HFP was dissolved in 3 ml of NMP under continuous stirring until the entire polymer was dissolved. 27 ml of ethyl alcohol was added to the solution. Finally, 0.500 g of fumed silica (SiO₂) of average particle size of less than 45 microns was added until a homogeneous suspension was obtained. The final composition of the suspension was 0.02 g of solids (83% Silica, 17% PVDF) per ml of liquid (90% ethanol, 10% NMP). The suspension was then sprayed by means of an ultrasonic sprayer, onto the surface of a Li-ion battery carbon anode (26 cm² area/side), kept at 150-200° C. A Scanning Electron Micrograph of a cross-section of the carbon anode was obtained to determine the thickness of the coated film. The micrograph shown in FIG. 3 indicated a thickness of about 10 to 20 micrometer for the film. The film was then gelled with one milliliter of an electrolyte solution consisting of a 1 molar (M) LiPF₆ in a 1:1:1 (by weight) mixture of EC:DMC:DEC.

### EXAMPLE 2

This example illustrates the preparation and characterization of electrodes coated with the composite polymer electrolytes of the invention using a different organic polymer. A suspension of fumed silica-PEO was prepared at room temperature in the following sequence. First, 0.100 g of poly(ethylene oxide),(PEO) was first melted and then dissolved in 3 ml of NMP under continuous stirring until the entire polymer was dissolved. 27 ml of ethyl alcohol was added to the solution. Finally, 0.500 g of fumed silica (SiO₂) of average particle size of less than 45 microns was added until a homogeneous suspension was obtained. The final composition of the suspension was 0.02 g of solids (83% Silica, 17% PEO) per ml of liquid (90% ethanol, 10% NMP). The suspension was then sprayed by means of an ultrasonic sprayer onto the surface of a Li-ion battery carbon anode (26 cm² area/side), kept at 150-200° C. The film was then gelled with one milliliter of an electrolyte solution consisting of a 1 molar (M) LiPF₆ in a 1:1:1 (by weight) mixture of EC:DMC:DEC.

### EXAMPLE 3

This example illustrates the preparation and characterization of electrodes coated with the composite polymer electrolytes of the invention using a different inorganic oxide. A suspension of alpha-Alumina (a-Al₂O₃)-PVDF was prepared at room temperature in the following sequence. First, 0.100 g of PVDF-HFP was dissolved in 3 ml of NMP under continuous stirring until the entire polymer was dissolved. 27 ml of ethyl alcohol was added to the solution. Finally, 0.500 g of alpha-Alumina of average particle size between 20 and 50 microns was added until a homogeneous suspension was obtained. The final composition of the suspension was 0.02 g of solids (83% Alumina, 17% PVDF) per ml of liquid (90% ethanol, 10% NMP). The suspension was then sprayed, by means of an ultrasonic sprayer, on to the surface of a Li-ion battery carbon anode (26 cm² area/side), kept at 150-200° C. The film was then wet with one milliliter of an electrolyte solution consisting of a 1 molar (M) LiPF₆ in a 1:1:1 (by weight) mixture of EC:DMC:DEC.

### EXAMPLE 4

This example illustrates the construction of a Li-ion coin cell made with the pre-constructed composite polymer electrolyte (PVDF-HFP/Alumina)-electrode assembly prepared in the previous example. The Li-ion coin cell was made with a MCMB carbon (1.98 cm²) anode and a LiNi_{0.8}Co_{0.2}O₂ (1.98 cm²) cathode. The electrolyte was 1 M LiPF₆ in a 1:1:1 ratio mixture of ethylene carbonate (EC)/dimethyl carbonate (DMC)/diethyl carbonate (DEC) and the separator was the Alumina-PVDF-HFP composite film. The coin cell was made in the standard way with the cathode and the anode sandwiching the composite polymer electrolyte separator. The electrolyte solution added to the coin cell was absorbed by the polymer electrolyte film that functions as the separator between the cathode and the anode and allows the transport of Li ions across the electrode. FIG. 4 illustrates the cycling data and shows the voltage profiles of the cell when cycled at different C rates (C/20, C/10, C/5, C/2, 2C, 4C, and 8C) between 3.0 and 4.1V.

### EXAMPLE 5

This example illustrates the construction of a Li-ion coin cell made with the pre-constructed composite polymer electrolyte-electrode assembly made with PEO/fumed silica. The Li-ion coin cell was made with a MCMB carbon (1.98 cm²) anode and LiNi_{0.8}Co_{0.2}O₂ (1.98 cm²) cathode. The electrolyte was 1 M LiPF₆ in a 1:1:1 ratio mixture of ethylene carbonate (EC)/dimethyl carbonate (DMC)/diethyl carbonate (DEC) and the separator was fumed silica/PEO composite film. The coin cell was made in the same way with the cathode, anode and the composite polymer electrolyte separator. The electrolyte solution added to the coin cell was absorbed by the film that functions as the separator between the cathode and the anode and allows the transport of Li ions across the electrode. FIG. 5 shows the voltage profiles of the cell when cycled between 3.0 and 4.1V at a current of 0.250 mA (approximately 0.13 mA/cm₂).

It will be understood that various modifications will be apparent to and can be made by those skilled in the art without departing from the spirit and scope of the invention. Accordingly, it is not intended that the claims appended herein be limited to the description as set forth herein, but rather that the claims be construed as encompassing all of the features of patentable novelty including all features that would be treated as equivalent thereof by those skilled in the art to which this invention pertains.

We claim:

1. An electric current producing rechargeable polymer battery comprising a positive electrode, a negative electrode and a composite polymer electrolyte interposed between said electrodes, said composite polymer electrolyte comprising a mixture containing a finely-divided inorganic oxide and an organic polymer, gelled with a non-aqueous electrolyte solution containing a lithium salt in an organic solvent, said composite polymer electrolyte serving also as a separator medium electronically insulating said electrodes while transporting lithium ions therebetween.

2. The rechargeable polymer battery of claim 1 wherein said composite polymer electrolyte is in the form of a thin film coating applied to at least one of said positive and negative electrodes.

3. The rechargeable polymer battery of claim 2 wherein said composite polymer electrolyte comprises from about 50 to about 95 percent by weight inorganic oxide and from about 5 to about 50 percent by weight organic polymer.

4. The rechargeable polymer battery of claim 3 wherein said inorganic oxide is selected from the group consisting of aluminum oxide (Al₂O₃), titanium oxide (TiO₂), silicon oxide (SiO₂) and mixtures thereof.

5. The rechargeable polymer battery of claim 4 wherein said organic polymer is selected from the group consisting of poly(vinylidene fluoride)-hexafluoropropene copolymer, (PVDF-HFP), poly(ethylene oxide), poly(propylene oxide), polyacrylonitrile, poly(vinyl pyrrolidinone) and mixtures thereof.

6. The rechargeable polymer battery of claim 5 wherein said inorganic oxide is silicon oxide (SiO₂) and said organic polymer is poly(vinylidene fluoride)-hexafluoropropene copolymer, (PVDF-HFP).

7. The rechargeable polymer battery of claim 5 wherein said lithium salt is selected from the group consisting of LiAsF₆, LiPF₆, LiBF₄, lithium imidazolide bis-(boron trifluoride), LiN(O₂SCF₃)₂, LiN(O₂SC₂F₅)₂, LiBOB, LiClO₄, and mixtures thereof.

8. The rechargeable polymer battery of claim 7 wherein said organic solvent is selected from the group consisting of organic carbonates, esters, ethers, lactones and mixtures thereof.

9. The rechargeable polymer battery of claim 8 wherein said organic solvent is a mixture of a cyclic carbonate and an acyclic carbonate.

10. The rechargeable polymer battery of claim 9 wherein said cyclic carbonate is ethylene carbonate and said acyclic carbonate is selected from the group consisting of dimethyl carbonate(DMC), diethyl carbonate(DEC), ethylmethyl carbonate and mixtures thereof.

11. The rechargeable polymer battery of claim 8 wherein said negative electrode is selected from the group consisting of graphitic carbon, lithium metal, lithium alloys and Li intercalating transition metal compounds.

12. The rechargeable polymer battery of claim 11 wherein said positive electrode is a transition metal oxide selected from the group consisting of V₃O₈, V₆O₁₃, LiCoO₂, LiMn₂O₄, LiNiₓM_{y}O₂ where x=0<x<0.6 and M=Co, Mn and y=0<y<0.6, LiNi_{0.33}Co_{0.33}Mn_{0.33}O₂, and LiMPO₄ where M=Fe, V, Mn and mixtures thereof.

13. A composite polymer electrolyte comprising a finely-divided inorganic oxide selected from the group consisting of aluminum oxide (Al₂O₃), titanium oxide (TiO₂), silicon oxide (SiO₂) and mixtures thereof and an organic polymer selected from the group consisting of poly(vinylidene fluoride)-hexafluoropropene copolymer, (PVDF-HFP), poly(ethylene oxide), poly(propylene oxide), polyacrylonitrile, poly(vinyl pyrrolidinone) and mixtures thereof, gelled with a non-aqueous electrolyte solution containing a lithium salt in an organic solvent.

14. An electrode-electrolyte assembly for use in the fabrication of a rechargeable polymer battery comprising a thin foil of electrochemically active material and a thin coating of a composite polymer electrolyte applied to a surface of said foil, said composite polymer electrolyte coating comprising a mixture containing a finely-divided inorganic oxide and an organic polymer, gelled with a non-aqueous electrolyte solution containing a lithium salt in an organic solvent.

15. A method of fabricating a rechargeable polymer battery comprising:
providing a positive and a negative electrode;
preparing a suspension of finely-divided inorganic oxide and an organic polymer dissolved in a solvent;
coating a surface of at least one of said electrodes with said suspension;
gelling the residue from said evaporated suspension with a non-aqueous electrolyte solution containing a lithium salt in an organic solvent, and
placing said coated electrode adjacent to the other of said electrodes with said gelled coating therebetween to form said polymer battery.

16. The method of fabricating a polymer battery according to claim 15 wherein said suspension comprises from about 50 to about 95 percent by weight inorganic oxide and from about 5 to about 50 percent by weight organic polymer.

17. The method of fabricating a polymer battery according to claim 16 wherein said inorganic oxide is selected from the group consisting of aluminum oxide (Al₂O₃), titanium oxide (TiO₂), silicon oxide (SiO₂) and mixtures thereof and wherein said organic polymer is selected from the group consisting of poly(vinylidene fluoride)-hexafluoropropene copolymer, (PVDF-HFP), poly(ethylene oxide), poly(propylene oxide), polyacrylonitrile , poly(vinyl pyrrolidinone) and mixtures thereof.

18. The method of fabricating a polymer battery according to claim 17 wherein said lithium salt is selected from the group consisting of LiAsF₆, LiPF₆, LiBF₄, lithium imidazolide bis(boron trifluoride), LiN(O₂SCF₃)₂, LiN(O2SC2F5)2, LiBOB, LiClO₄, and mixtures thereof and wherein said organic solvent is selected from the group consisting of organic carbonates, esters, ethers, lactones and mixtures thereof.

19. The method of fabricating a polymer battery according to claim 18 wherein said negative electrode is selected from the group consisting of graphitic carbon, lithium metal, lithium alloys, and Li intercalating transition metal compounds and wherein said positive electrode is a transition metal oxide selected from the group consisting of V₃O₈, V₆O₁₃, LiCoO₂, LiMn₂O₄, LiNiₓM_{y}O₂ where x=0<x<0.6 and M=Co, Mn and y=0<y<0.6, LiNi_{0.33}Co_{0.33}Mn_{0.33}O₂, and LiMPO₄ where M=Fe, V, Mn and mixtures thereof.

20. The method of fabricating a polymer battery according to claim 19 wherein said suspension comprises fumed silica in a solution of poly(vinylidene fluoride)-hexafluoropropene copolymer (PVDF-HFP) in N-methyl pyrrolidinone and ethyl alcohol.
